(19) United States
(12) Patent Application Publication
(10) Pub. No.: US 2006/0212434 A1
(43) Pub. Date: Sep. 21, 2006

(54) System and method for customization and streamlining of Web site navigation

(75) Inventors: Blanche I. Crawford, Manassas, VA (US); Doreen Daly, Sterling, VA (US); Nancy Knode, Indianapolis, IN (US)

Correspondence Address: DICKSTEIN SHAPIRO LLP, 1825 EYE STREET NW, Washington, DC, 20006-5403, US

(73) Assignee: Sallie Mae, Inc.

(21) Appl. No.: 11/372,093

(22) Filed: Mar. 10, 2006

Related U.S. Application Data
(60) Provisional application No. 60/660,338, filed on Mar. 11, 2005.

(51) Int. Cl. G06F 17/30

(52) U.S. Cl. 707/3

(57) ABSTRACT

A computer-based system and method for customizing navigation through a Web site based upon values of user information received from either an external or internal Web site upon entering the customized Web site. The Web site customization includes both customized navigation and functionality. Users are directed through the Web site in a streamlined manner, and information entered in the external or internal Web site is pre-populated so the user does not have to re-enter information already given. The Web site also customizes the navigation and functionality available to the particular user based on the information entered and on the entry point, therefore bypassing any unnecessary displays and avoiding redundancy.

### CROSS REFERENCE TO RELATED APPLICATION

This application claims the benefit of U.S. Provisional Patent Application No. 60/660,338, filed Mar. 11, 2004, the disclosure of which is incorporated herein by reference in its entirety.

### FIELD OF THE INVENTION

The present invention relates to a method and system for customizing a Web site based upon values of user related information received from either an external or internal source, such as a Web site. The Web site customization includes customized navigation and functionality. The present invention enables users to be directed through the Web site in a streamlined manner, to not have to re-enter information already given, and to bypass displays that are redundant.

### BACKGROUND OF THE INVENTION

In many fields it is increasingly common for business to be conducted via a service provider's or vendor's Web site. For example, in the financial aid industry, the user would link directly to the financial aid institution's Web site in order to conduct business. Typically, if the user links to the financial aid institution's Web site from an external Web site, that user would have to then navigate to another external lender site to apply for a loan and re-enter information the user had already entered on the financial aid institution's Web site. The present invention allows any type of Web site, including a financial institution's Web site, to capture and send information to an external Web site and/or drive a specific process. The financial aid institution's Web site, for example, can then use this information to customize the navigation and functionality available to the user, or to streamline the user's visit Web site. The invention also enables the user's information to be pre-populated on the pages of the external Web site (e.g., a lender's site) so that the user does not have to re-enter the information multiple times. As noted above, the principles of the present invention are applicable to any Web site application and are by no means limited to financial institutions.

### BRIEF SUMMARY OF THE INVENTION

The present invention is a computer-based system and method for allowing a first Web site to receive and use information that is entered into a second Web site, either external or internal to the first Web site. This avoids having an entity or individual re-select or re-enter information during the Web Session, saving time and avoiding repetition. The present invention also allows the Web site to customize the navigation and functionality available to the user based on the information entered, therefore bypassing any unnecessary screens, based on the particular user.

### BRIEF DESCRIPTION OF THE DRAWINGS

FIG. 1 is a block diagram of the system according to an exemplary embodiment of the invention;

FIG. 2 is a format chart showing navigation points and parameters for an exemplary embodiment of the present invention;

FIG. 3 is a flow chart showing the method for the apploansummary navigation point of an exemplary embodiment of the present invention;

FIG. 4 is an exemplary flow of data for given parameters for the apploansummary navigation point of an exemplary embodiment of the present invention;

FIG. 5 is a flow chart showing the method for the cosigner navigation point of an exemplary embodiment of the present invention;

FIG. 6 is an exemplary flow of data for given parameters for the cosigner navigation point of an exemplary embodiment of the present invention;

FIG. 7 is a flow chart showing the method for the private navigation point of an exemplary embodiment of the present invention;

FIG. 8 is an exemplary flow of data for given parameters for the private navigation point of an exemplary embodiment of the present invention;

FIG. 9 is an exemplary flow of data for given parameters for the parentanswer navigation point of an exemplary embodiment of the present invention;

FIG. 10 is a flow chart showing the logic for the schoollogin navigation point of an exemplary embodiment of the present invention;

FIG. 11 is a flow chart showing the logic for the lenderlogin navigation point of an exemplary embodiment of the present invention; and

FIG. 12 is a flow chart showing the logic for the fms navigation point of an exemplary embodiment of the present invention;

### DETAILED DESCRIPTION OF THE INVENTION

The invention comprises a computer-based system and method for allowing a Web site, and in one exemplary embodiment a financial aid institution's Web site, to store and pre-populate previously input information, thereby avoiding having the user, such as a consumer, reselect or re-enter such information during the Web Session. It also allows the Web site to customize the navigation and functionality available to the consumer based on the information entered.

For purposes of this application, a query string is the portion of a dynamic Uniform Resource Locator that contains parameters, which are passed to a server. In the present invention, the query string contain parameters that determine navigation into the Web site, formatting information, and other content that allows pages to be provided to a user based on the user's input.

An exemplary embodiment of the invention is described below in the context of the banking and loan industry, and particularly the student loan/financial aid industry. However, it should be understood that the present invention is not so limited and could readily be applied to other applications both within and outside the financial industry. Other financial industry exemptions include online payments and mortgage, personal and car loans. Other applications or industries also covered by the present invention include, but are not limited to: human resources applications, such as administering health and dental care services, managing 401K plans, providing for stock options and purchases, managing employee time recordation and payroll, managing business travel, and facilitating the administration of other benefits; insurance industry applications, such as health, auto, life, and home owner's insurance; various applications in hospitals and pharmacies, such as patient histories and records; travel industry applications, such as airline, car rental, and hotel industries; online business applications, such as managing the interaction between online stores and online payment centers; employment recruiting applications, such as managing the interaction between job search engines and resume services or companies posting positions; education industry applications, such as administering tests and managing test results, e.g., licensing exams, SATs, GMAT; and/or real estate industry applications, such as managing the interaction between an agent's Web site and online property listings among others.

The query string functionality of the present invention provides a specific web-entry point into a Web site depending upon the values of the parameters provided on the query string. Examples of possible entry points may include a borrower login page, a school choice page, or a terms of service page. Specific examples of this entry point will be discussed in relation to the exemplary embodiment, below. The system will also store the values of the parameters as provided and pre-populate these values into the appropriate fields on the Web site. The system continues to pre-populate the values of the parameters passed on the query string as long as the user is in the same web session.

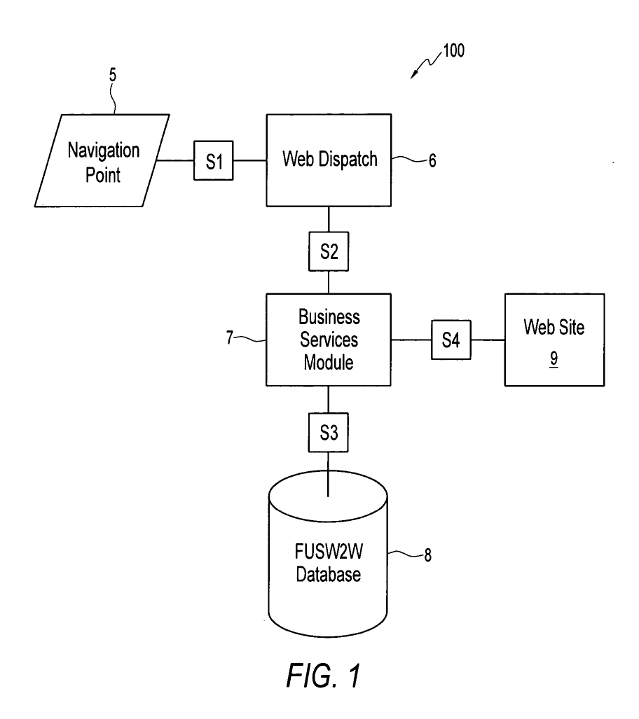

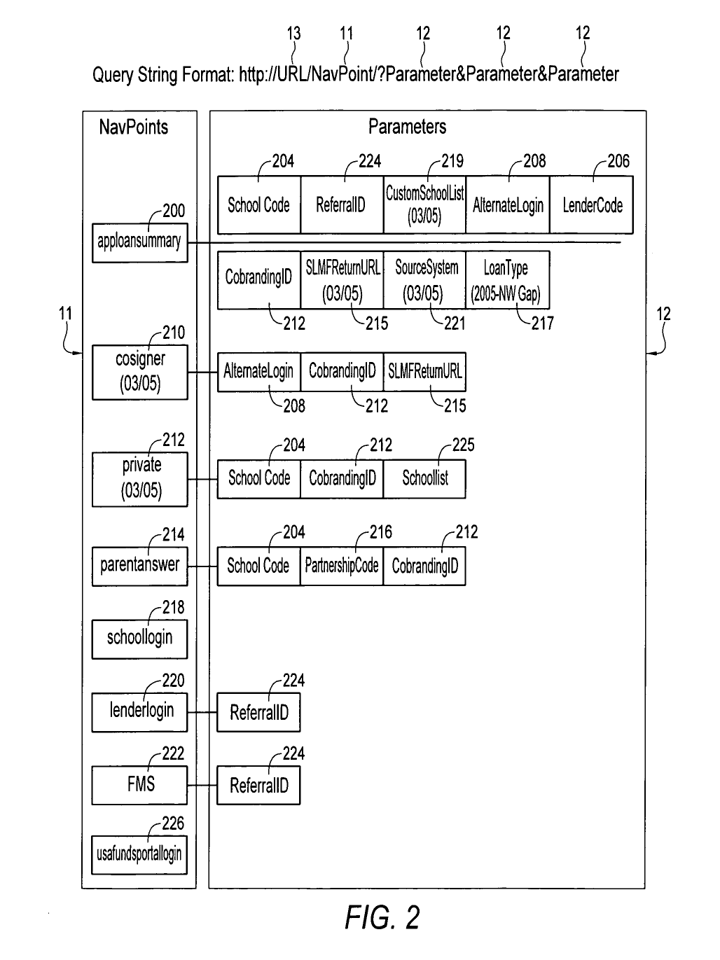

FIG. 1 depicts a block diagram and logical overview of an exemplary embodiment of the system 100 of the present invention. The web dispatch 6 receives an incoming request (S1) from the navigation point 11. The navigation point 11 defines the point of entry for the Web site 9 and is included in a query string. The navigation point 11 (and parameters (FIG. 2)) are dispatched to the business service module 7 (S2). At step S3, the business service module 7 determines if the incoming request matches a profile in the database 8. Constants tied to the requested configuration are retrieved (not shown). Dynamic parameters 12 (FIG. 2) passed in the query string are maintained. At step S4, the business service module 7 redirects users to the appropriate location within the Web site 9 as defined by the navigation point 11. The user session is established for the specified entry point, and parameters 12 passed in the query string are persisted in the session and applied as specified by defined requirements. The entry point is the display to which the user is taken upon entering the Web site 9 and is defined by the navigation point 11 (FIG. 2) and the value of the parameters 12 passed on the query string, as described in more detail below.

The smart query string functionality is supported by a business service module 7 that includes validation, translation and dispatch abilities in order to dispatch information provided on the query string to the appropriate system 100 component. Navigation points 11 are configurable and they interrogate the query string requests.

The business service module 7 can each be computer program applications running on one or more servers (not shown). The Web site 9 can also be hosted by a server. The one or more servers are in communication with the database 8 and can be included in a computer network.

The exemplary system 100 allows customers of a financial aid institution to apply for financial aid and manage their accounts through the query string based Web site 9. Students and parents may access the application and cosigner sections of the Web site 9 by linking directly from their school's financial aid webpage, or any other external site linking them to the application information. Also, school administrators and lenders may enter directly to portions of the Web site 9 relevant to them through particularized navigation points.

As shown in FIG. 2, the functionality of the invention (smart query string functionality) is driven by three main components: the domain/URL 13, a specified navigation point from the plurality of navigation points 11, and parameters 12 which correspond with a specified navigation point 11. The combination of these components drives navigation, can allow GUI pages to be bypassed, and if desired, can drive functionality once the user session is established. An example of the format of a query string is as follows:

http://URL 13/NavPoint 11/?Parameter 12&Parameter 12&Parameter 12

The exemplary domain/URL 13 is set up as a standard domain and a masked domain. A masked domain serves as an alternative domain when the default domain cannot be used. The present invention, however, does not require the use of a masked domain. Regardless of whether the default or alternate domain is passed, the system 100 will retain the URL passed in the query string that represents the domain information. Typically, the standard domain is utilized, i.e. “www.financial_institution_name.com.” The standard domain leverages the masked domain and allows for special relationships between the financial institution domain and sites that require different treatment than most others, for example, an educational institution's site that requires the removal of the financial aid institution's branding. For purposes of this specification, branding refers to the indication of the source or sponsorship, for example a mark or logo indicating that a Web site or page is presented or sponsored by a particular entity.

The specified navigation point 11 and the values of the chosen parameters 12 drive the entry point once the user session is established. Non-exclusive examples of navigation points 11, as shown in FIG. 2, include the following: apploansummary 200, cosigner 210, private 202, parentanswer 214, schoollogin 218, lenderlogin 220, FMS 222, and Usafundsportallogin 223. Each navigation point 11 has optional parameters associated with it that are available in the query string. Parameters 12 corresponding with each particular navigation point 11 of an exemplary embodiment are shown in FIG. 2. These parameters 12 further define navigation and application processing functionality. The parameters 12 which are available are predetermined based on the navigation point 11 which is chosen. Examples of parameters that may be used in association with all of the navigation points of the exemplary embodiment include, but are not limited to: SchoolCode 204 (which identifies the user's school), ReferralID 224 (which identifies the logo image to be displayed on the page), PartnershipCode 216 (which identifies a tracking code ties to the loan record), CustomSchoolList 219 (which identifies a pre-defined list of schools), AlternateLogin 208 (which controls limited access to the Web site 9), LenderCode 220 (which identifies the lender), CobrandingID 212 (which determines the look and feel of the Web site 9, e.g., the images and color scheme for the Web site 9 during a particular web session), SLMFReturnURL 215 (which identifies a return navigation option for the user at the end of the flow), and SourceSystem 221 (which triggers business rules and behaviors within the flow). Moreover, each navigation point has a relationship with particular parameters, although navigation points may have some parameters in common with others. For example, the navigation point cosigner 210 is associated with the parameters AlternateLogin 208, CobrandingID 212, and SLMFReturnURL 215 and not with all the other parameters available to the rest of the navigation points.

The navigation points drive the entry point into the Web site 9 once a user session is established. For example, the navigation point apploansummary 220 takes a user to the web page(s) for applying for a new loan. For example, in one embodiment, the navigation point apploansummary 220 takes the user to the borrow version of OpenNet, where the user can apply for a new loan, complete an existing loan, or check the status of a loan. The navigation point cosigner 210 takes a loan's cosigners to the web page(s) having the cosigner's portion of a loan application. The navigation point private 202 directs a user to the web page(s) for applying for a private loan. The navigation point parentanswer 214 allows a user (typically a parent or guardian user) to access an application processing flow with specific and custom requirements for the SallieMae PLUS loan program. The navigation point schoollogin 218 takes a user (typically a school administrator) to the login page specific to school users for entry to the school version of OpenNet. The navigation point lenderlogin 220 takes a user (typically a lender) to the appropriate login page for entry to the lender version of OpenNet. The navigation point FMS takes a user to a login page for entry into the File Management System. The navigation point Usafundsportallogin 223 takes a user to the login page for the United Student Aid Funds (USAF) Portal, which is an external Web site that allows users to manage loans.

Often, users will access the Web site 9 after navigating through an external Web Page, for example, a school's financial aid informational Web site, where information is collected from the user or where the user makes a selection. For example, the user may select a lender they wish to use from the list of available lenders on the school's Web site. The school's Web site will in turn navigate the user to the Web site 9 passing the SchoolCode 204 (known because the site is specific to the school) and the LenderCode 206 (known because of the selection made by the user) on the query string. Rather than requiring the user to re-enter this information once he has entered the Web site 9, the information passed as parameters on the query string allows navigation that, in the exemplary embodiment, bypasses the school and lender selection requirements and pre-populates the web page(s) with the values passed.

The parameters 12 can also cause the displays of the Web site 9 to look differently from one user to the next, based upon the values of the parameters 12. For example, if ReferralID 224 is passed as a parameter on the query string, the financial aid institution's webpage can show text representing the partnership with the referring institution. This query string functionality is not limited to parameter values passed from an external Web site and can also be used during navigation within the Web site 9.

Query string data can be limited to parameters 12 that will not expose private data. Private data can include information such as social security numbers, among other information. Such private data is excluded from the parameters 12 of the query string to avoid unsecured exposure of the information. Instead, the system 100 can be configured to pass private data via an SSL form post which is used primarily by external customers. Private data can also be passed server-to-server at the same time users are physically redirected to a different Web site, without using the query string functionality.

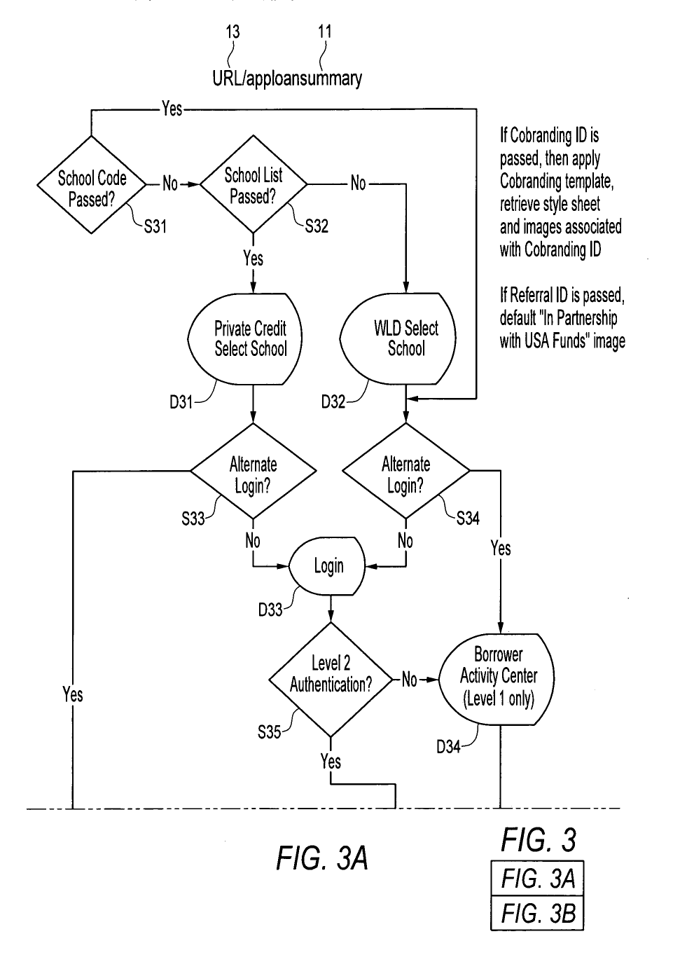

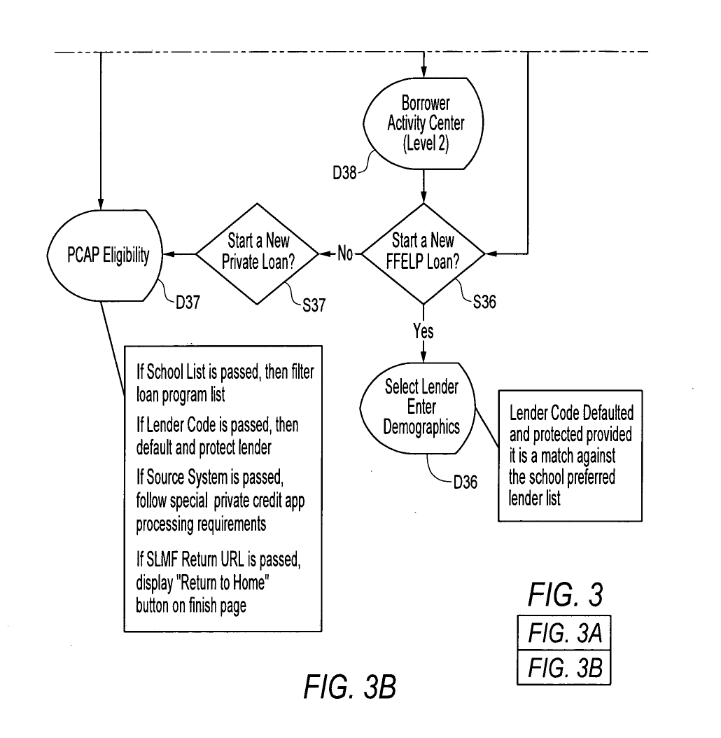

FIGS. 3 through 12 depict several examples of the use of the query string functionality based on an exemplary embodiment of the present invention.

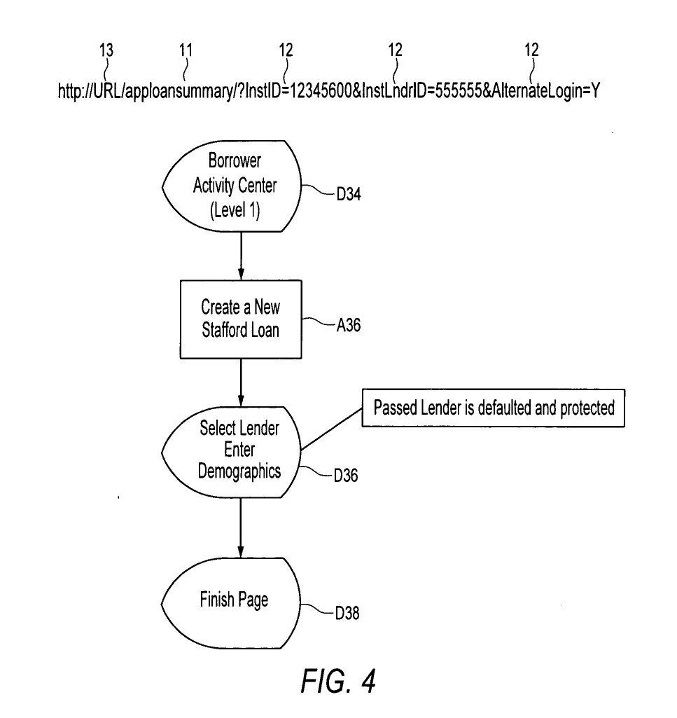

In FIGS. 3 and 4, an exemplary flow of data in an application of the exemplary embodiment is shown. The navigation point demonstrated in these figures is apploansummary 200 (FIG. 2), which supports a new loan application. When the user enters the Web site 9 at this navigation point, the relevant parameters associated with the navigation point apploansummary 200 are passed through the portal on a query string to the Web site 9. Examples of the relevant parameters include information regarding the student's school, any pre-specified lender, or a cobranding ID. The logic by which the application uses the parameters passed on the query string is shown in FIG. 3. FIG. 4 shows an example of specific query string parameters being passed to the navigation point.

FIG. 3 demonstrates the logic flow for the particular navigation point apploansummary 200 (FIG. 2). If the CobrandingID 212 is passed, a cobranding template is applied and the style sheet and images associated with the CobrandingID 212 are used for all displays. The cobranding template determines the look (and/or feel) of the Web site 9 based upon the identity of the parties co-sponsoring the site. From the application apploansummary 200 navigation point, a user can navigate into the borrower version of OpenNet, where the user can apply for a new loan, complete an existing loan application, and check on the status of a loan.

Step S31 determines if a SchoolCode 204 has been passed as a parameter in the query string. If a SchoolCode 204 was passed, the Select School display D32 is bypassed; the entry point is either the Login display D33 or the Borrower Activity Center display D34 (discussed below). If the school code was not present, then step S32 determines whether the parameter SchoolList 225 (an optional parameter that can be passed with the Private navigation point 202) has been passed. If the SchoolList was passed, the “select private loan program” field is automatically chosen and the user is taken to a user interface to select the school D31 which is tailored to a private loan selection user. If the SchoolList 225 was not passed, the user is taken to a different user interface to select the school D32 which is not specifically tailored. If the SchoolCode 204 is not passed, then the entry point is the Select School display D31, 32.

The next step from each of these Select School displays D31, D32 is Alternate Login S33, S34, which establishes a Level 1 authentication that limits a user's capability to creating a new loan application. Data retrieval stored secure data is not allowed with only Level 1 authentication. Each of these Alternate Login S33, S34 steps has a different result for a “yes” answer. If Alternate Login S33 is “yes,” the user will be shown the private credit application processing (PCAP) option. Eligibility display D37 which is the entry point when selecting an option to start a new private loan. At this display, any parameters that were passed on the query string will be defaulted and settings will be chosen based on the values of the parameters, as shown in FIG. 2. For example, if the SchoolList 225 parameter is passed, the loan program list is filtered to show only available loans for the specified school(s) or if the LenderCode 206 is passed then this lender is defaulted and protected on the page. If Alternate Login S34 is “yes,” the user is taken to the Borrower Activity Center D34 (description below), which is the entry point if the SchoolCode 204 and Alternate Login 208 were passed.

If either Alternate Login step S33, S34 is “no,” the system 100 takes the user to the Login display D33 where the user enters a user ID and password for Level 2 authentication and authorization. In the exemplary embodiment, Level 2 provides a greater range of rights and user options. From the Login display D33, the system 100 evaluates the Level 2 Authentication S35 based on the user assertions applied when the user ID and password are authenticated. Level 2 authentication differs from Level 1 authentication in that the two levels provide different rights and thus wider access to functions and information for the user. If Level 2 Authentication S35 is “no” (or if Alternate Login S34 is “yes”), the user will be navigated to the Borrower Activity Center (Level 1) display D34, which authorizes functionality for the user that supports Level 1 authentication privileges. If Level 2 Authentication S35 is “yes,” the user will be navigated to the Borrower Activity Center (Level 2) display D38, which authorizes functionality for the user that supports level 2 authentication privileges.

The Borrower Activity Center D34, D38 is a task oriented menu based upon school profiles, status of loan data, and smart query string navigation. Possible options at the Borrower Activity Center D34, D38 include creating new applications, completing existing applications, viewing loans, and updating user profiles. From both Borrower Activity Centers D34, D38 the system 100 will determine if the user selected to start a new Federal Family Education Loans Program (FFELP) loan S36 from the options in the Borrower Activity Center D34, D38. If “yes,” the user is shown the Select Lender Enter Demographics display D36 which is the first page the user navigates to when selecting the option to start a new FFELP loan; the lender code will be defaulted and protected if it is a match against the school preferred lender list. If step S36 is “no,” the user is shown the PCAP Eligibility display D37, previously described, to apply for a private loan.

FIG. 4 is an example of a specific query string that could be sent to the navigation point apploansummary 200 and demonstrates the flow for a specific set of parameters. The parameters which are passed in the given example are SchoolCode 204, LenderCode 206, and AlternateLogin 208. The flow diagram in FIG. 4 shows the sequence of displays the user would see when entering the Web site 9 through the portal from the navigation point apploansummary 200 with the given parameters; this set of displays is a subset of those shown in FIG. 3.

As shown in FIG. 3, the user is able to bypass the displays to choose a school D31, D32 and the Login display D33 and go directly to the Borrower Activity Center display D34 since the SchoolCode 204 and AlternateLogin 208=Y were passed on the query string. In other words, the Borrower Activity Center display D34 is the entry point. More specifically, from step S31, the path for “yes” is followed (because the SchoolCode was passed) to step S34, which is also “yes.” Referring to FIG. 4, the Borrower Activity Center (Level 1) display D34, the user selects “Create a New Stafford Loan” A36 from the options available on the Borrower Activity Center (Level 1) display D34, and is navigated to (by way of S36=“yes”) the Select Lender/Enter Demographics D36 section of the Web site 9. Here, any parameter values passed on the query string (in the example, SchoolCode 204 and LenderID 206) are defaulted so that the user does not have to reselect them. The user will then complete the loan application process and will be shown the Finish Page display D38, which is the final user interface within the FFELP loan application processing flow.

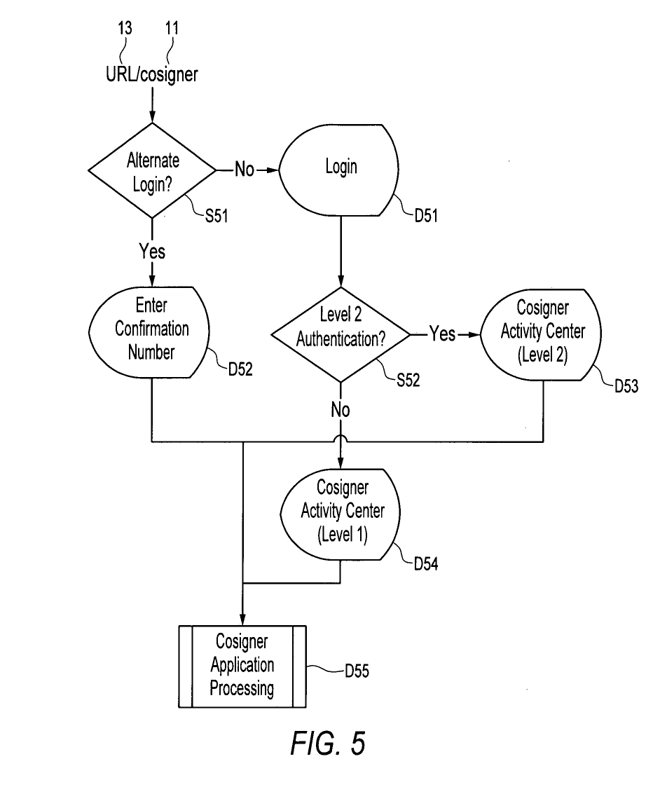

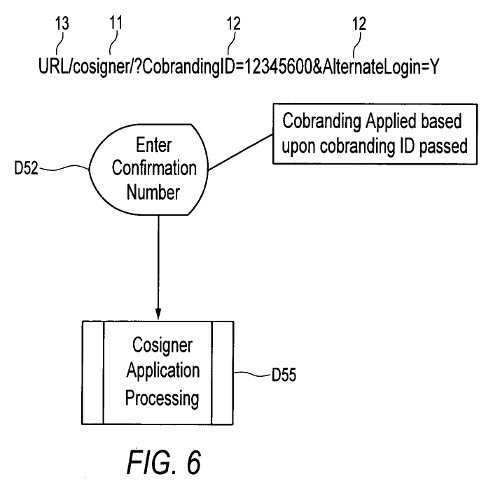

In FIGS. 5 and 6, an exemplary flow of data in an application of the exemplary embodiment is shown. The navigation point demonstrated in these figures is cosigner 210, which supports functionality allowing the cosigner of an existing loan application to enter the system 100 and fill out his/her portion of the application form. When the user enters the Web site 9 at this navigation point, the relevant parameters associated with the navigation point cosigner 210 are passed through the portal on a query string to the Web site 9. The logic by which the application uses the parameters passed on the query string is shown in FIG. 5. FIG. 5 shows an example of specific query string parameters being passed to the navigation point.

FIG. 5 demonstrates the logic flow for the particular navigation point cosigner 210. From this navigation point, a user can input the necessary information to serve as a cosigner for a loan. When the user enters the Web site 9 through the cosigner navigation point 210, if the CobrandingID 212 is passed, a cobranding template is applied and the style sheet and images associated with the CobrandingID 212 are used for all displays. Next, the system 100 determines, at step S51, the value of the Alternate Login 208 parameter passed. A valid AlternateLogin 208 establishes a Level 1 authentication that limits consumer capacity to creating a new loan application. Retrieval of security stored data is not allowed with only Level 1 authentication. The entry point with a valid AlternateLogin 200 is the Enter Confirmation Number display D52 where the user will enter information that will establish a cosigner application processing user session. This information may include the name of the person for whom they are cosigning or a loan ID for this person's loan. Assuming the information entered by the user matches an open application, the system 100 will direct the user to the Cosigner Application Processing display D55.

If Alternate Login S51 is “no,” the entry point is the Login display D51 where the user must enter a user ID and password for authentication and authorization. From the Login display D51, the system 100 will determine Level 2 Authentication S52 which is evaluated based on the user assertions applied when the user ID and password are authenticated. If Level 2 Authentication is not achieved, the user is shown the Cosigner Activity Center (Level 1) display D54, which authorizes functionality for the user that supports Level 1 authentication privileges. If Level 2 Authentication is achieved, the user is shown the Cosigner Activity Center (Level 2) display D53, which authorizes functionality for the user that supports Level 2 authentication privileges. From each of the Cosigner Activity Center displays D54, D53 the user is navigated to the Cosigner Application Processing display D55 and completes the cosigner application procedure.

FIG. 6 is an example of a specific query string that could be sent to the navigation point cosigner 210 and demonstrates the flow for a specific set of parameters. The parameters which are passed in the given example are CobrandingID 212 and AlternateLogin 208. The flow diagram in FIG. 6 shows the displays the user would see when entering the Web site 9 through the portal from the navigation point cosigner with the given parameters; this set of displays is a subset of those shown in FIG. 5. As shown, the user is able to bypass the Login display D51 since a valid AlternateLogin 200 was passed on the query string. At the Cosigner Application Processing display D55 any information passed on the query string will be pre-populated for the user. Additionally, the Cobranding will be applied based upon the CobrandingID 212 having been passed. Thus, the style and images of the pages is determined based on the value of this parameter.

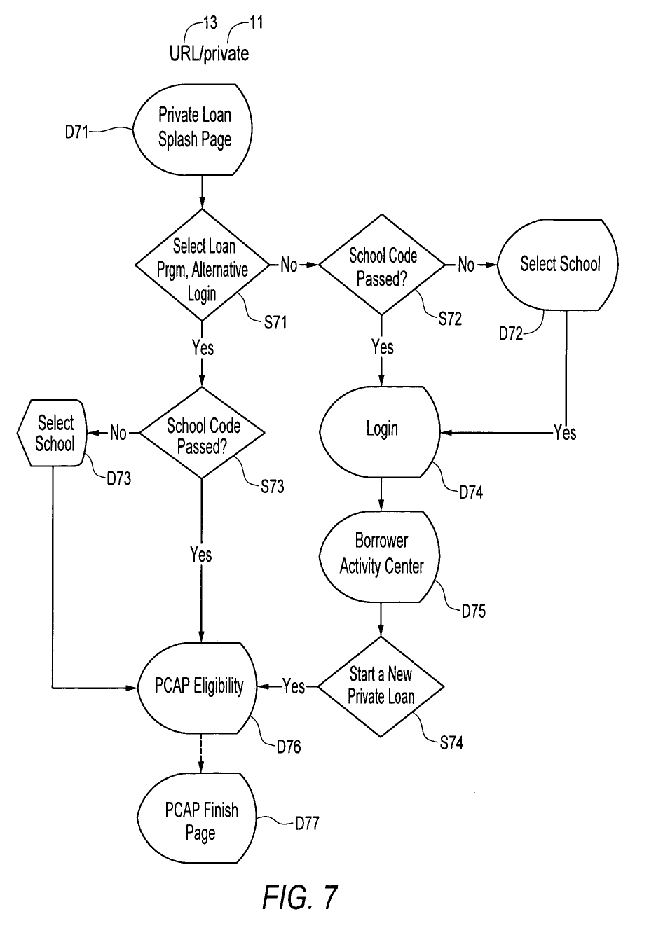

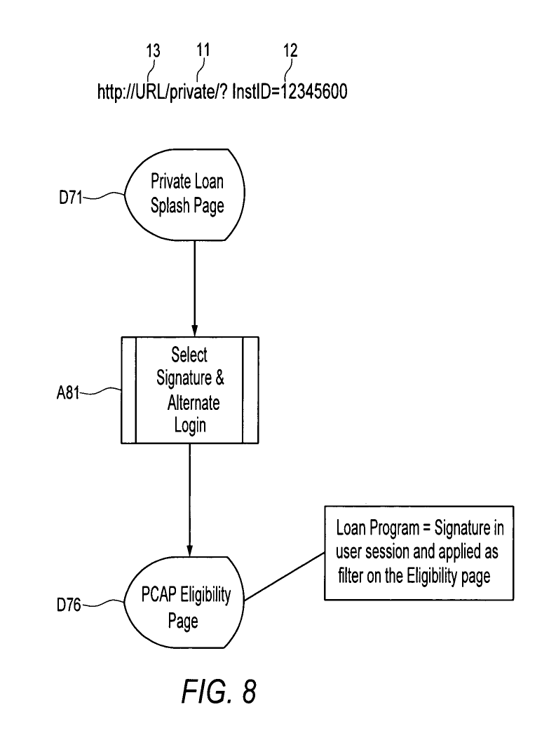

In FIGS. 7 and 8, flow of data in an application of the exemplary embodiment is shown. The navigation point demonstrated in these figures is private 202, which supports functionality allowing a user to apply for a new private loan. When the user enters the Web site 9 at this navigation point, the relevant parameters associated with the navigation point private 202 are passed through the portal on a query string to the Web site 9. The logic by which the application uses the parameters passed on the query string is shown in FIG. 7. FIG. 8 shows an example of specific query string parameters being passed to the navigation point.

FIG. 7 demonstrates the logic flow for the particular navigation point private. When the user enters the Web site 9 through the private navigation point, the user is first shown the Private Loan Splash Page display D71 which is the entry point when the private navigation point is used. The system 100 then determines if the user selected a specific loan program and the alternative login at the Select Loan Program, Alternative Login step S71. The loan program choice is a selection option for the user on the Private Loan Splash Page display D71. If in step S71 a valid AlternateLogin 208 is passed, the system 100 determines if the SchoolCode 204 has been passed at step S73. If in step S71 no valid AlternateLogin 208 is passed, the system 100 determines if the SchoolCode 204 was passed, at step S72.

If the response to either of steps S72 or S73 is “no,” the user is navigated to the Select School display D72, D73, which is a user interface where the user may select a school. Once a school is selected at D73, the user is navigated to the PCAP Eligibility display D76. Once a school is selected at D72, the user is shown the Login display D74. The user is also taken directly to the Login display D74 if the system 100 determines a SchoolCode 204 was passed in step S72. At the Login display D74, the user enters a user ID and password for authentication and authorization.

From the Login display D74, the user is directed to the Borrower Activity Center display D74, which is a task-oriented menu from which the user can choose to start a new private loan. The system 100 detects whether the user has selected to start a new private loan S74. If so, the user is shown the PCAP Eligibility display D76. The PCAP Eligibility display D76 is the first page the user navigates to when selecting the option to start a new private loan from the Borrower Activity Center display D75 or when selecting a private loan with the SchoolCode 204 already having been passed. Once the user completes the application process, they are shown the PCAP Finish Page display D77.

FIG. 8 is an example of a specific query string that could be sent to the navigation point private 202 and demonstrates the flow for a specific set of parameters. The parameter which is passed in the given example is SchoolCode 204. The flow diagram in FIG. 8 shows the flow of displays the user would encounter when entering the Web site 9 through the portal from the navigation point private 202 with the given parameter; this set of displays is a subset of those shown in FIG. 7. In this example, the user selects “Signature” and “Alternate Login” from the Private Loan Splash Page display D71 at A81. Therefore, the response to step S71 of FIG. 7 is “yes.” At step S73, the system 100 determines that SchoolCode 204 has been passed and takes the user to the PCAP Eligibility display D76, where “Signature” is the loan program selected for the user session and is applied as a filter on the eligibility page D76.

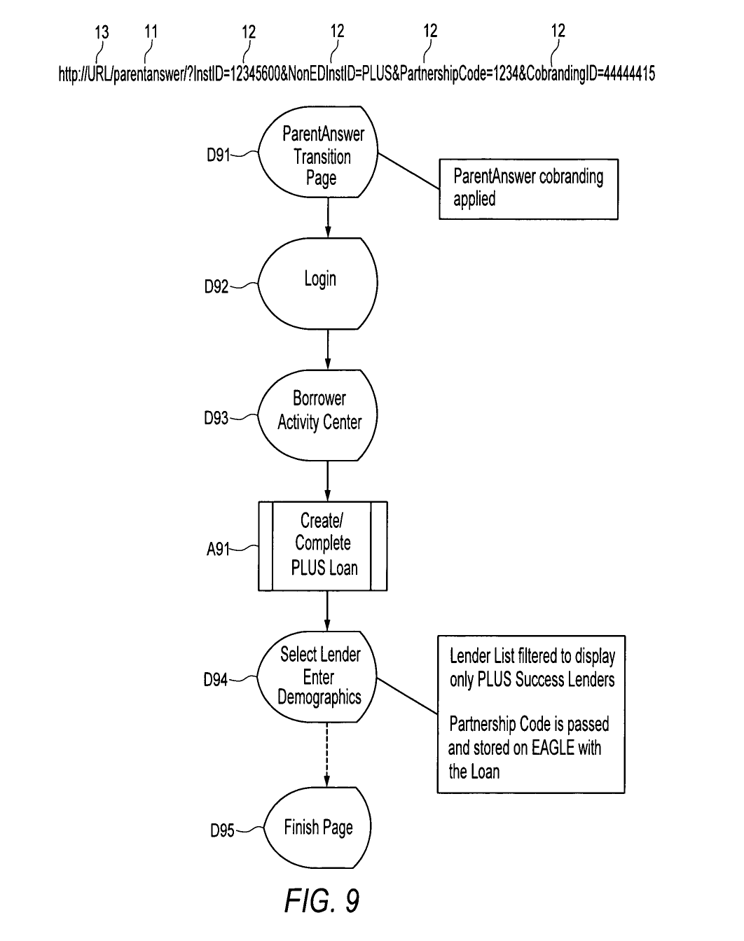

FIG. 9 is an example of a specific query string that could be sent to the navigation point parentanswer 214 and demonstrates the flow for a specific set of parameters. The parentanswer navigation point 214 (FIG. 2) allows a user to access an application processing flow with specific and custom requirements for the SallieMae PLUS loan program. The parameters which are passed in the given example are SchoolCode 204, PartnershipCode 216, and CobrandingID 212. The flow diagram in FIG. 9 shows the displays the user would see when entering the Web site 9 through the portal from the navigation point parentanswer 214 with the given parameters. When entering through the parentanswer navigation point 214, the first display the user sees is the ParentAnswer Transition Page display D91 which explains to the user why he/she is transitioning to a new Web site and gives user instructions. The user then is taken to the Login display D92 where he/she enters a user ID and password for authentication and authorization. The user is directed to the Borrower Activity Center display D93 which is a task-oriented menu from which the user can select many options. In this example, the user selects Create/Complete PLUS loan at A91. He/she is then taken to the Select Lender/Enter Demographics display D94 where the lender list is filtered to display only PLUS Success lenders since the user selected the PLUS loan option at A91 and the Partnership code that was passed on the query string and is stored with the loan in the lender's storage system.

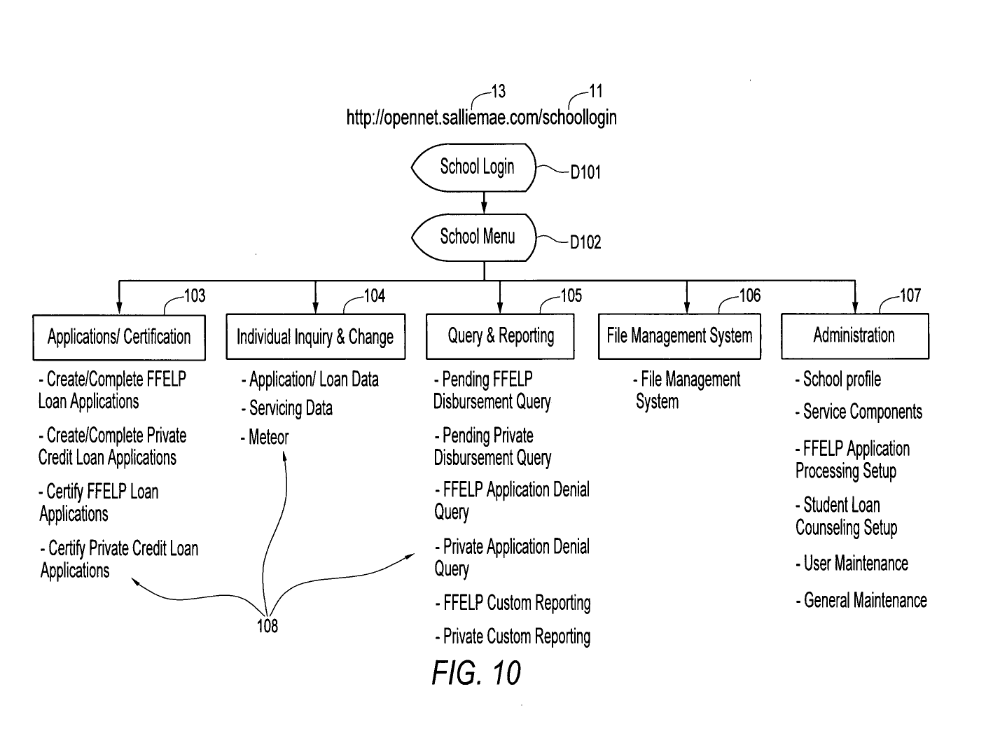

FIGS. 10, 11, and 12 show the logic application flows for the schoollogin 218, lenderlogin 220, and fms 222 navigation points, respectively.

FIG. 10 shows the logic flow for the schoollogin 218 navigation point, which directs a school administrator to the appropriate login page and school specific portions of the Web site 9. Upon entering the site at the navigation point, the user is first taken to the School Login display D101 where the user institution enters its user ID and password for authorization. Then the user is taken to the School Menu display D102 which is the user interface for user type school and is an activity-oriented menu.

Applications/Certification 103, Individual Inquiry and Change 104, Query and Reporting 105, File Management System 106 and Administration 107 are each menu categories available at the School Menu display D102 and the corresponding menu options 108 are shown below each in FIG. 10. The user can select from among the menu options 108. Upon selecting a menu option 108, the user is taken to the user interface corresponding to the selected option. For example, if the user selects the School Profile option 108 from the Administration 107 category, the user is taken to the user interface for viewing and modifying their school's profile.

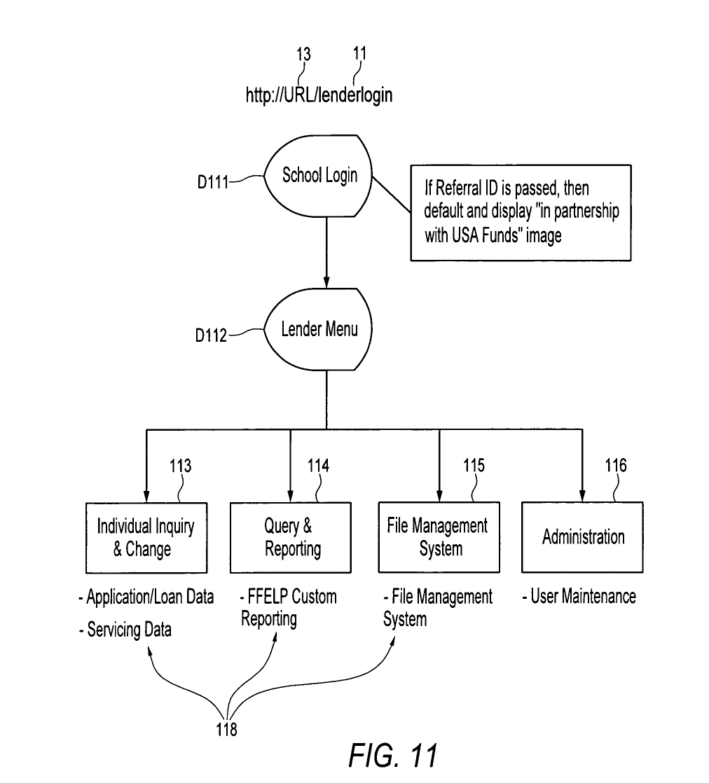

FIG. 11 shows the logic flow for the lenderlogin navigation point 220, which takes a lender to the Lender Login page and under specific portions of the Web site 9. Upon entering the site at the navigation point, the user is first taken to the Lender Login display D111, where the user institution enters its user ID and password for authorization. If Referral ID 224 (FIG. 2) is passed, then the Lender Login display D111 will automatically display the “In partnership with USA funds” image. The user is then taken to the Lender Menu display D112 which is the user interface for user type lender or lender servicer and is an activity-oriented menu. Individual Inquiry and Change 113, Query and Reporting 114, File Management System 115 and Administration 116 are each menu categories available at the Lender Menu display D112 and the corresponding menu options 118 are shown below each FIG. 11.

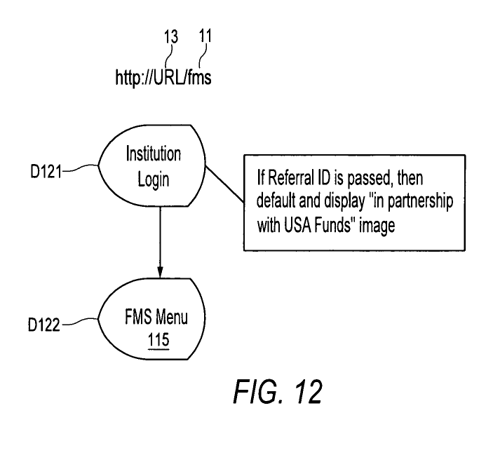

FIG. 12 shows the logic flow for the fms navigation point 222, which allows a user entry into the File Management System. A typical user of the File Management System is a school administrator or school technical staff. On the File Management System, the user is able to send and receive CommonLine files; view and correct errors for CommonLine files that failed to send; and view the status and details of CommonLine files sent or received for their institution. Upon entering the site at the navigation point, the user is first taken to the Institution Login display D121, where the user institution enters its user ID and password for authorization. If Referral ID 224 (FIG. 2) is passed, then the Institution Login display D121 will automatically display the “In partnership with USA funds” image. The user is then taken to the FMS Menu display D122 which is an activity-oriented menu for the File Management System 115 category.

Other sets of navigation points and query string parameters may be available that go beyond those provided in connection with the exemplary embodiment described above. For example, navigation points and query string parameters specific to a particular application, such as a mortgage loan or human resources application or any of the other alternative applications previously described; or navigation points and parameters specific to an alternative embodiment for student loan administration.

What is claimed as new and desired to be protected by Letters Patent of the United States is:

1. A computer system comprising:
at least one server linked to a first Web site directly or through a computer network, the first Web site providing a user interface;
the first Web site having a World Wide Web address and configured to comprise at least one navigation points the at least one navigation point determining an entry point of a session into the first Web site a second Web site for selecting in each said navigation point; and
at least one parameter associated with each navigation point, wherein a value of each parameter is definable by input into the second Web site, said parameter and determining navigation through the first Web site.

2. The computer system of claim 1, wherein at least one navigation point and the values of at least one parameter obtained at the second Web site are passed to the first Web site on a query string.

3. The computer system of claim 1, wherein the values of the parameters define information to be pre-populated into web forms on the first Web site.

4. The computer system of claim 1, wherein the values of the parameters define navigation through the first Web site by allowing portions of the first Web site to be bypassed, wherein the portions bypassed would have received information that is contained in the values of the parameters.

5. The computer system of claim 1, wherein the World Wide Web address is a URL.

6. The computer system of claim 5, wherein the URL is set up as a standard domain and a masked domain.

7. The computer system of claim 1, wherein the first Web site is for providing financial aid services.

8. The computer system of claim 7, wherein the navigation point directs the user to portions of the first Web site for applying for a loan.

9. The computer system of claim 8, wherein the parameters associated with the navigation point includes at least one parameter from the group consisting of: a school identifier, login information, a lender identifier, a cobranding identifier, a loan type identifier, a custom school list, and a referral identifier.

10. The computer system of claim 7, wherein the navigation point directs a user to portions of the first Web site for cosigners.

11. The computer system of claim 10, wherein the parameters associated with the navigation point include at least one of login information and/or a cobranding identifier.

12. The computer system of claim 7, wherein the navigation point directs the user to portions of the first Web site for applying for a private loan.

13. The computer system of claim 12, wherein the parameters associated with the navigation point include at least one of a school identifier and a cobranding identifier.

14. The computer system of claim 7, wherein the navigation point takes the user to portions of the first Web site for applying for a PLUS loan.

15. The computer system of claim 14, wherein the parameters associated with the navigation point include a school identifier, a cobranding identifier, and/or a partnership code identifier.

16. The computer system of claim 7, wherein the navigation directs the user to portions of the first Web site for school administrators manage the school account.

17. The computer system of claim 7, wherein the navigation point directs the user to portions of the first Web site for lenders.

18. The computer system of claim 17, wherein the parameters associated with the navigation point include a referral identifier.

19. The computer system of claim 7, wherein the navigation point takes the user to a file management system.

20. The computer system of claim 19, wherein the parameters associated with the navigation point include a referral identifier.

21. The computer system of claim 7, wherein the navigation point takes the user to an external Web site for managing a loan.

22. A server system comprising:
a means for communicating with at least one first Web site, the first Web site providing a user interface, having a World Wide Web address and configured to comprise:
at least one navigation point, the at least one navigation point determining an entry point of a session into the first Web site a second Web site for selecting in each said navigation point, and
at least one parameter associated with each navigation point, wherein a value of each parameter is definable by input into the second Web site and, said parameter determining navigation through the first Web site.

23. The server system of claim 22, wherein the navigation point and the values of the parameters obtained at the second Web site are passed to the first Web site on a query string.

24. The server system of claim 22, wherein the values of the parameters are pre-populated into web forms on the first Web site.

25. The server system of claim 22, wherein the values of the parameters define navigation through the first Web site by allowing the user to bypass portions of the first Web site, wherein the portions bypassed would have received information from the user that is contained in the values of the parameters.

26. The server system of claim 22, wherein the World Wide Web address is a URL.

27. The server system of claim 26, wherein the URL is set up as a standard domain and a masked domain.

28. The server system of claim 22, wherein the first Web site is for providing financial aid services.

29. A method for customizing navigation through a first Web site based on user input, the method comprising:
receiving data input into a second Web site;
choosing a navigation point from at least one navigation point related to the first Web site based on the inputted data, the navigation point defining an entry point into the first Web site;
defining a value of at least one parameter associated with the one of a plurality of navigation points, the value being determined based on the imputed data; and
directing a user to the entry point within the first Web site based on the defined navigation point and value of the at least one parameter such that the user is not required to re-enter any previously entered information, the previously entered information being stored as at least one value of a parameter.

30. The method of claim 29, wherein the first Web site is configured to provide financial aid services.

31. The method of claim 30, wherein the user is directed to portions of the first Web site for applying for a loan based on the defined navigation point.

32. The method of claim 31, wherein the parameters associated with the navigation point includes at least one parameter from the group consisting of: a school identifier, login information, a lender identifier, a cobranding identifier, a loan type identifier, a custom school list, and a referral identifier.

33. The method of claim 31, wherein the entry point is defined as a user interface to select a school.

34. The method of claim 31, wherein the entry point is defined as a user interface to login.

35. The method of claim 31, wherein the entry point is defined as a user interface allowing the user to select options related to applying for a new loan.

36. The method of claim 30, wherein the user is directed to portions of the first Web site for cosigning for a loan.

37. The method of claim 36, wherein the entry point is defined as a user interface to login.

38. The method of claim 36, wherein the entry point is defined as a user interface to enter confirmation information regarding the loan the user is cosigning.

39. The method of claim 36, wherein the parameters associated with the navigation point include at least one of login information and a cobranding identifier.

40. The method of claim 30, wherein the user is directed to portions of the first Web site for applying for a private loan based on the defined navigation point.

41. The method of claim 40, wherein the entry point is defined as a user interface allowing the user to select options related to applying for a private loan.

42. The method of claim 40, wherein the parameters associated with the navigation point include at least one of a school identifier and a cobranding identifier.

43. The method of claim 30, wherein the user is directed to portions of the first Web site for applying for a PLUS loan.

44. The method of claim 43, wherein the entry point is defined as a user interface providing information about the financial institution's Web site.

45. The method of claim 43, wherein the parameters associated with the navigation point include at least one of a school identifier, a cobranding identifier, and a partnership code identifier.

46. The method of claim 30, wherein the user is a school administrator and is directed to portions of the first Web site managing a school account.

47. The method of claim 46, wherein the entry point is defined as a user interface allowing the school administrator to login.

48. The method of claim 30, wherein the user is a lender and is directed to portions of the first Web site for managing a lender account.

49. The method of claim 48, wherein the entry point is defined as a user interface allowing the lender to login.

50. The method of claim 48, wherein the parameters associated with the navigation point include a referral identifier.

51. The method of claim 30, wherein the user is directed to a file management system.

52. The method of claim 51, wherein the parameters associated with the navigation point include a referral identifier.

53. The method of claim 30, wherein the user is directed to p an external Web site for managing a loan.

54. A computer program product comprising a computer useable medium having computer logic stored therein, the computer program logic for enabling a computer to navigate through a first Web site, wherein the computer program logic comprises:
a means for receiving data input into a second Web site;
a means for determining a navigation point from a plurality of navigation points related to the first Web site based on the imputed data, the navigation point defining an entry point into the first Web site;
a means for defining a value of at least one parameter associated with the one of a plurality of navigation points, the value being determined by the data input by the user; and
a means for directing a user to the entry point and within the first Web site such that the user is not required to re-enter any previously entered information, the previously entered information being stored as at least one value of a parameter.

55. The computer program product of claim 54, wherein the first Web site is configured to provide financial aid services.

56. A Web site for providing a user interface, the Web site comprising:
a plurality of Web pages, wherein the Web pages are configured such that a first Web page presented to a user during a user session is based on user input from a location outside the Website, and wherein the functionality available to the user on each Web page presented to the user during the user session is defined by at least one parameter determined user input.

57. The Web site of claim 56, wherein the at least one parameter is configured such that the user is not required to re-enter any information previously entered by the user.
